(19) United States
(12) Patent Application Publication
(10) Pub. No.: US 2006/0236778 A1
(43) Pub. Date: Oct. 26, 2006

(54) Measuring assembly for ice adhesion

(75) Inventor: Thomas A. DeVilbiss III, Rochester Hills, MI (US)

Correspondence Address: CLARK HILL, P.C., 500 WOODWARD AVENUE, SUITE 3500, DETROIT, MI, 48226, US

(73) Assignee: The Magni Group, Inc., Birmingham, MI (US)

(21) Appl. No.: 11/110,217

(22) Filed: Apr. 20, 2005

(51) Int. Cl. G01N 3/08

(52) U.S. Cl. 73/827

(57) ABSTRACT

A measuring assembly measures the adhesion between a fixed part and a movable part wherein the fixed part and movable part have ice extending therebetween. The measuring assembly includes a chamber for maintaining the ice, the fixed part and the movable part and the movable part at a predetermined temperature. A tension generator applies a force to the movable part to separate the movable part from the fixed part. A tension gauge measures the force required to overcome the adhesion between the movable part and the ice to remove the movable part from the fixed part. The test pieces (fixed and movable parts) are easily reproduced and coated with various coatings allowing direct comparison and evaluation of coatings in regards to ice adhesion.

### BACKGROUND ART

1. Field of The Invention

The invention relates to a measuring assembly used to measure the adhesion of ice. More specifically, the measuring assembly is designed to measure the adhesion of ice between coated parts that are designed to move relative to each other.

2. Description of the Related Art

When mechanical components of an assembly are exposed to freezing environment, their function can sometimes deviate from the originally designed intent. This is especially true when two components are exposed to ice. When moisture covering the components freezes, the components may stick together resulting in reduced functionality of those components or other components related to the frozen components.

In most applications, these components are coated with a coating that inhibits corrosion. These coatings may have properties that facilitate the movement of one component relative to another. These coatings enhance the feel of the operation of mechanisms and maintain that feel over a longer period of time. In other words, these coatings reduce friction and prevent corrosion allowing the reduced frictional properties to be maintained over a longer period of time. There is a need to be able to evaluate the performance of these coatings in a freezing environment.

Currently, there is no known test of these coatings to determine whether these coatings will operate when moisture freezes around the components other than building a complete assembly and testing it in a “freezing” environment. Such practice is normally expensive and excessively time consuming. This invention allows for an inexpensive and timely comparison of different coatings. While a coating may have excellent friction reducing properties above freezing temperatures, it may not operate well below freezing temperatures. In an attempt to measure the properties of coatings that are exposed to moisture below freezing temperatures, a testing apparatus needs to be able to isolate variables in the testing procedure so that a coating may be tested precisely controlling several of the variables during the testing procedure.

### SUMMARY OF THE INVENTION

A measuring assembly measures the adhesion between a fixed part and a movable part wherein the fixed part and movable part have ice extending therebetween. The measuring assembly includes a chamber for maintaining the ice, the fixed part and the movable part at a predetermined temperature. A tension generator applies a force to the movable part to separate the movable part from the fixed part. A tension gauge measures the force required for the movable part to overcome the adhesion to the fixed part that results from the presence of ice.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention with a cover removed from a freezing chamber;

FIG. 2 is a top view of the invention;

FIG. 3 is a rear perspective view, partially cut away of the invention;

FIG. 4 is a side view of the invention;

FIG. 5 is a perspective view, partially cut away, of the chamber used in the invention;

FIG. 6 is a side view of the front portion of the invention;

FIG. 7 is a cross-sectional side view of a holder and a test piece frozen in place; and

FIG. 8 is a cross-sectional side view of a holder elevated to remove the test piece from the frozen parts.

### DETAILED DESCRIPTION OF THE PREFERRED EMBODIMENT

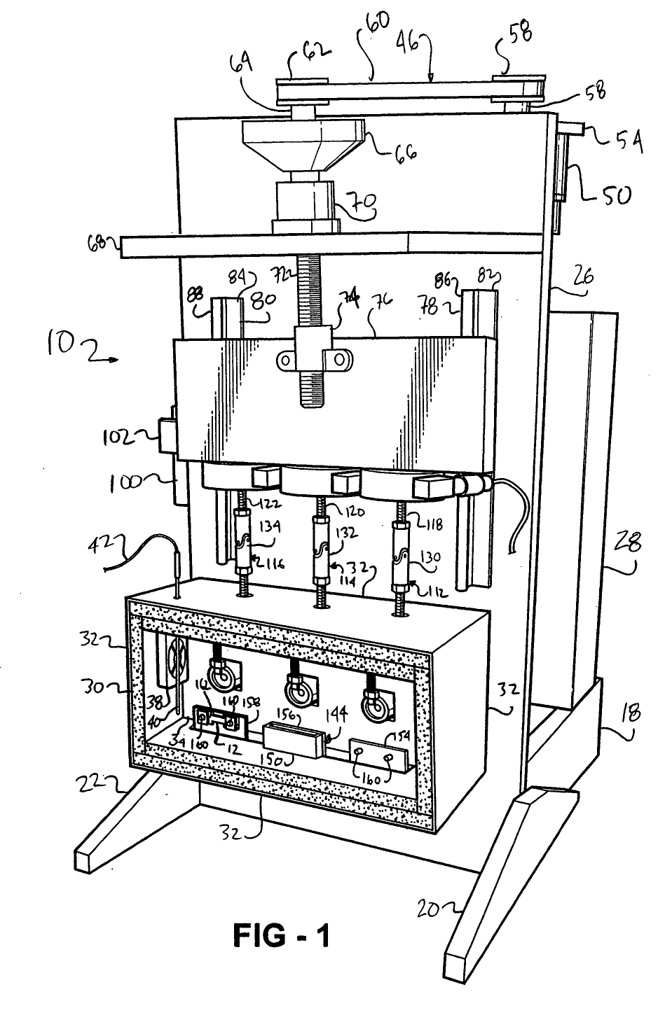

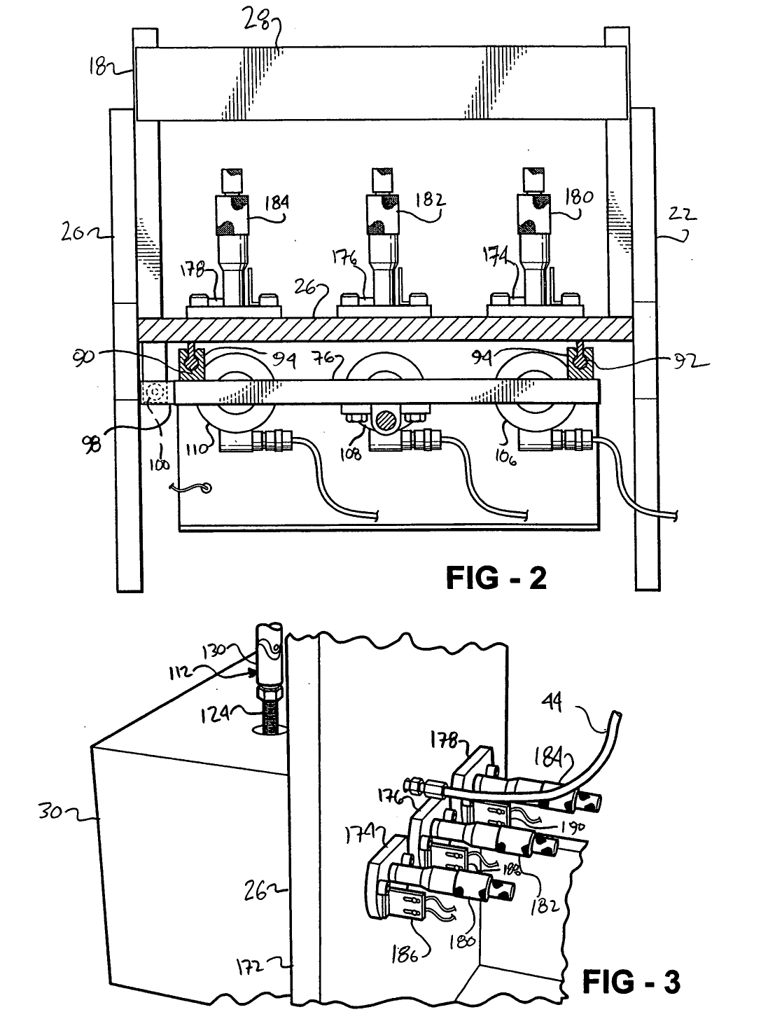

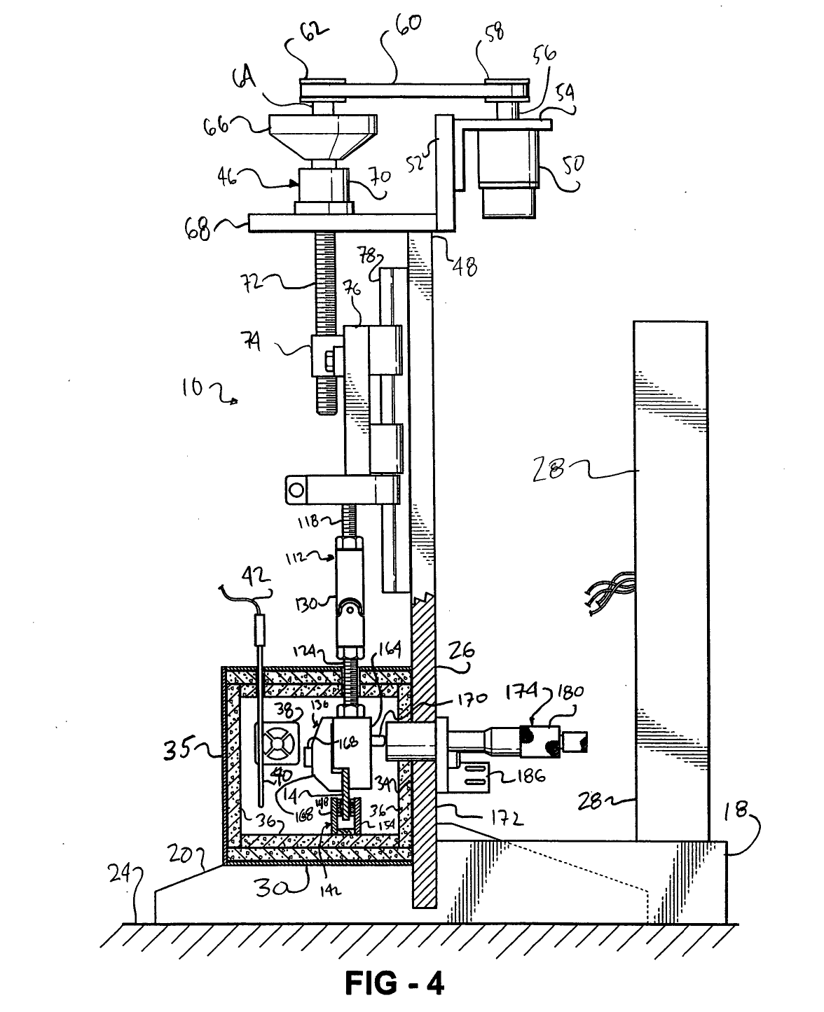

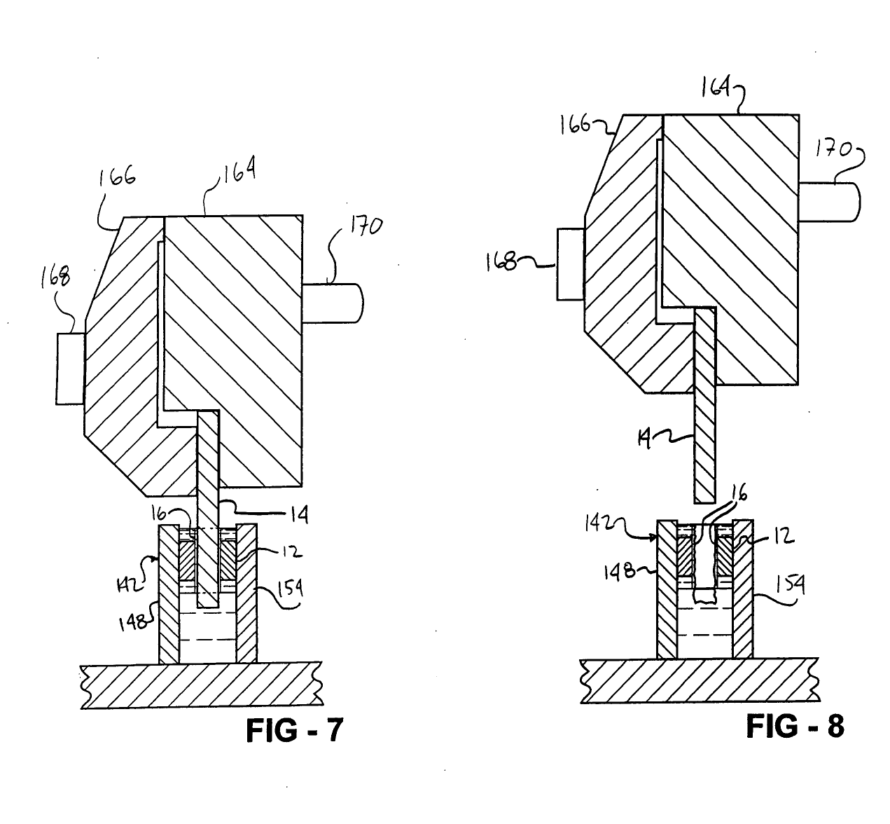

Referring to FIG. 1, a measuring assembly is generally indicated at 10. The measuring assembly 10 is used for measuring the adhesion between a fixed part 12 and a movable part 14 (shown in FIGS. 4 and 6 through 8) with ice 16 extending therebetween. The ice 16 is shown in FIGS. 7 and 8. The measuring assembly 10 provides an opportunity to test the parts 12, 14 with a plurality of different coatings in a controlled setting enabling direct comparison of the coating with regard to their respective interaction (adhesion) with ice.

The measuring assembly 10 includes a base 18 and two base extensions 20, 22 extending out therefrom to stabilize the measuring assembly 10 on a lab bench 24. The measuring assembly 10 includes a first tower 26 that is used to position all the operating components of the measuring assembly 10 appropriately. These components will be discussed in greater detail subsequently. The measuring assembly 10 also includes a second tower 28. The second tower 28 houses all of the electronics used to control and operate the measuring assembly 10. It should be appreciated by those skilled in the art that a single housing including the first 26 and second 28 towers could be incorporated into the measuring assembly 10. Further, the second tower 28 could be removed entirely if the control electronics and measuring electronics were mounted to the first tower 26 or even separated completely from the measuring assembly 10 and operatively connected to the measuring assembly 10 through a wireless protocol, such as radio frequency, wireless fidelity, optical and the like.

The measuring assembly 10 includes a chamber 30 that is fixedly secured to the first tower 26. The chamber 30 maintains the ice 16, the fixed part 12 and the movable part 14 at a predetermined temperature. Because the measuring assembly 10 is designed to measure the adhesion of certain coatings with respect to the build up of ice 16, the predetermined temperature in which the chamber 30 is maintained is below freezing. The chamber 30 is rectangular in shape and includes four sides 32, a back side 34, and a removable front cover 35. All interior surfaces of the chamber 30 are insulated with layers of insulation 36.

The chamber 30 also includes a convection fan 38 which circulates the air inside the chamber 30 to maintain the temperature inside the chamber 30 as consistent as possible throughout the interior space of the chamber 30. A temperature sensor 40 extends down into the interior portion of the chamber 30. The temperature sensor 40 is operatively connected to the controls of the measuring assembly 10 through an electrical conductor 42 (shown partially cut away in FIG. 4). The temperature sensor 40 provides feedback to the control unit to determine when the temperature inside the chamber 30 should be adjusted.

Referring to FIG. 3, a backside of the first tower 26 is shown. Extending through a portion of the first tower 26 and the backside 34 of the chamber 30 is a conduit 44. The conduit 44 is connected to and is a graphic representation of a cooling system (not shown) that is controlled by the controls of the measuring assembly 10. The cooling system is a liquid nitrogen system whereby liquid nitrogen is allowed to flow through the conduit 44 and into the chamber 30 to cool the interior thereof. It should be appreciated by those skilled in the art that other cooling systems may be incorporated into the measuring assembly 10 without changing the inventive concept of the measuring assembly 10. Therefore, the temperature sensor 40 works as a feedback loop for the cooling system that injects liquid nitrogen through the conduit 44 into the chamber 30 to maintain the temperature inside the chamber 30 at the desired temperature. The desired temperature may vary depending on the test being performed and the coating that is being tested.

Referring to FIG. 4, a measuring assembly 10 includes a tension generator, generally shown at 46. The tension generator 46 is mounted at a top portion 48 of the first tower 26. The tension generator 46 includes a motor 50 which is mounted to the first tower 26 via an extension 52 and a bracket 54. The bracket is an L-shaped bracket 54.

The motor 50 has an output shaft 56 that drives an output pulley 58, which in turn drives a belt 60 to translate the output force of the motor 50 laterally with respect to the motor 50.

Driven by the belt 60 is a drive pulley 62. The drive pulley 62 is fixedly secured to a drive shaft 64. A fly wheel 66 is also fixedly secured to the drive shaft 64 at a location spaced from the drive pulley 62. The flywheel 66 may be used to smooth the operation of the motor 50. In addition, the flywheel can act as a handle to manually rotate the drive shaft 64 should such manual operation be required.

The drive shaft 64 is mounted to the first tower 26 via a lateral extension 68, which is supported by a bracket (not shown). A bearing 70 is fixedly secured to the lateral extension 68 and positions the drive shaft 64 therethrough. A hole (not shown) extends through the lateral extension 68 allowing the drive shaft 64 to extend through the lateral extension 68 and down one side of the first tower 26.

Below the lateral extension 68, the drive shaft 64 includes a threaded portion 72. The threaded portion 72 of the drive shaft 64 acts as a lead screw because the drive shaft 64 does not move axially. It only moves rotationally. A follower 74 threadingly engages the threaded portion 72 whereby rotation of the drive shaft 64 translates into axial movement of the follower 74 up and down the threaded portion 72 of the drive shaft 64. Therefore, the follower 74 translates the rotational movement of the drive shaft 64 and the motor 50 into axial movement 74 along the drive shaft 64 coaxially therewith.

A slide 76 is fixedly secured to the follower 74. The slide 76 has a width that is almost as long as a width of the first tower 26. Two guides 78, 80 are fixedly secured to the first tower 26 and extend vertically and parallel to each other. The guide 78, 80 include mounting portions 82, 84 and engagement portions 86, 88 respectively. In one embodiment, the engagement portions 86, 88 include cylindrical distal ends 90, 92. The slide 76 includes upper 94 and lower 96 guide mounts on either side of the slide 76. The slide 76 and guides 78, 80 facilitate the smooth transition of the slide axially up and down in response to the rotation of the threaded portion 72 of the drive shaft 64. Other mechanisms for guiding the follower are possible.

The slide 76 includes a measuring bracket 98 on one side thereof. The measuring bracket 98 abuts a linear measuring device 100 which is used to accurately identify the position of the slide 76 at any given time. The linear measuring device 100 is fixedly secured to the first tower 26 via a bracket 102.

The slide 76 defines a lower surface 104 which extends perpendicular to each of the guides 78, 80. The lower surface 104 is flat. Three tension gauges 106, 108, 110 are fixedly secured to the lower surface 104 of the slide 76. Three tension gauges 106-110 are used as a matter of convenience allowing the testing of three movable part 14/fixed part 12 combinations at a time. It should be appreciated by those skilled in the art that the measuring assembly 10 can be constructed with the capability of testing only a single movable part 14/fixed part 12 combination. The tension gauges 106-110 measure the force required to overcome the adhesion between the movable part 14 and the ice 16 to remove the movable part 14 from the fixed part 12.

Extending down from each of the gauges 106-110 are three extensions 112, 114, 116. Each of the extensions 112-116 includes an upper portion 118, 120, 122 and a lower portion 124, 126, 128. A universal joint 130, 132, 134 extends between the upper portions 118-122 and the lower portions 124-128, respectively. The universal joints 130-134 provide two degrees of freedom for the lower portions with respect to the upper portions 118-122. This allows for the proper positioning of the movable part 14 with respect to the fixed part 12.

The lower portions 124-128 extend through holes in one of the four sides 32 of the chamber 30. Fixedly secured to each of the lower portions 124-128 are holders 136, 138, 140. The holders removably secure a movable part 14 to the lower portion 124-128 of the extension 112-116. The holders 136-140 will be discussed in greater detail subsequently.

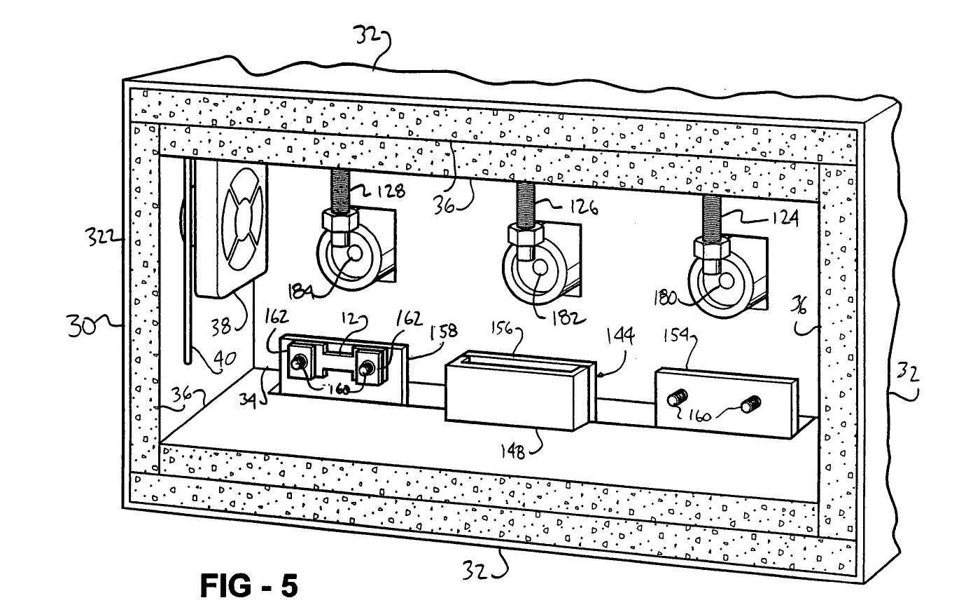

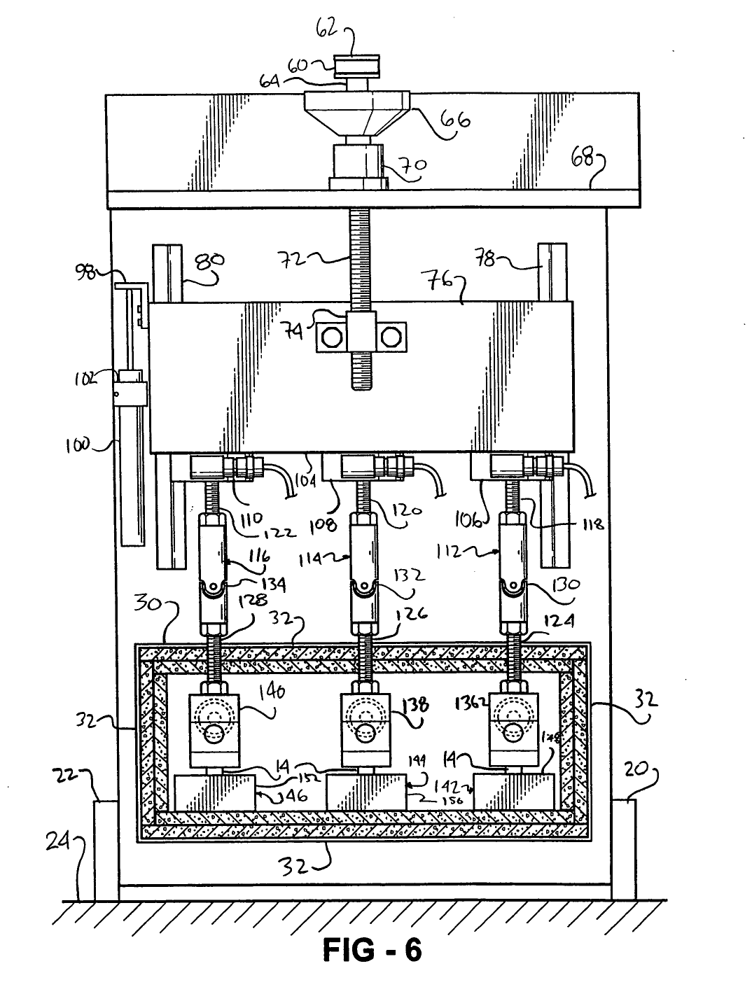

Returning attention to the chamber 30, three reservoirs 142, 144, 146 are generally shown in FIG. 6. Turning attention to FIG. 5, it can be seen that the reservoirs 142-146 include two parts, they being a partial cup 148, 150, 152 and an abutment plate 154, 156, 158. A gasket (not shown) is disposed between the partial cups 148-152 and the abutment plates 154-158 to prevent fluid from leaking out of the reservoirs 142-146 between the two parts that make each reservoir 142-146. Clamps (also not shown) are used to secure the partial cups 148-152 to the abutment plates 154-158. The abutment plates 154-158 are fixedly secured to a bottom side 32 of the chamber 30. Mounting screws 160 extend out of each of the abutment plates 154-158 to allow the fixed part 12 and any necessary spacing shims 162 to be secured thereto within the reservoirs 142-146.

The holders 136-140 include a positioning half 164 and a tightening half 166. The movable part 14 is secured therebetween after a bolt 168 forces the tightening half 166 into the positioning half 164. The positioning half 164 includes a lateral positioning stem 170 which will be discussed in greater detail subsequently. The holders 136-140 are fixedly secured to the lower portions 124-128 of the extensions 112-116.

Fixedly secured to a lower portion 172 of the first tower 26 are lateral adjusters 174, 176, 178. The lateral adjusters move the movable part 14 laterally with respect to the fixed part 12 to a predetermined distance. Each of the lateral adjusters includes a micrometer 180, 182, 184 that extends through the first tower 26 and the backside 34 of the chamber 30. Each micrometer 180-184 includes feedback circuitry 186, 188, 190 which provides a signal to the controls allowing manual adjustment of the lateral position of the movable part 14 to ensure that each is positioned appropriately with respect to the fixed part 12. The ends of the micrometers abut the lateral positioning stem 170 of each of the holders 136-140. Each micrometer 180-184 includes a switch (not shown) that disengages the drive mechanism, thereby preventing accidental damage to the device.

Once the movable part 14 is in position with respect to the fixed part 12, water is poured into the reservoirs 142-146. Typically a syringe (not shown) is used to transfer the water to each of the reservoirs 142-146, thus ensuring an accurate amount of water is poured into each of the reservoirs 142-146. The chamber 30 is then closed by securing the front cover 35 to the chamber 30. Liquid nitrogen is then fed through the conduit 44 to cool the chamber 30 to the desired temperature. Once the ice 16 is formed, the micrometers 180-184 are retracted away from the holders 136-140 to prevent damage to the micrometers 180-184. The motor 50 is then started to pull the slide 76 upwardly. This, in turn, pulls the movable parts 14 away from the fixed parts 12. The tension gauges 106-110 measure the force required to remove the movable part 14 from the ice 16 and away from the fixed part 12. These calculations may be used to identify coatings on the fixed part 12 and movable 14 that enhance the ability of the movable part 14 to move with respect to the ice 16 and the fixed part 12. While the invention disclosed shows a lateral configuration wherein the movable part 14 is moved laterally with respect to the fixed part, the measuring assembly 10 may be configured such that the movable part 14 may be moved in a rotational sense with respect to the fixed part.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

What is claimed:

1. A measuring assembly for measuring adhesion between a fixed part and a movable part having ice extending therebetween, said measuring assembly comprising:
a chamber for maintaining the ice, the fixed part and the movable part at a predetermined temperature;
a tension generator for applying a force to the movable part to separate the movable part from the fixed part; and
a tension gauge for measuring the force required to overcome the adhesion between the movable part and the ice to remove the movable part from the fixed part.

2. A measuring assembly as set forth in claim 1 including a reservoir to hold the ice therein.

3. A measuring assembly as set forth in claim 2 including a lateral adjuster for moving said movable part laterally with respect to said fixed part to a predetermined distance.

4. A measuring assembly as set forth in claim 3 including a slide extending between said tension gauge and said tension generator to move said tension gauge and said movable part vertically with respect to said reservoir.

5. A measuring assembly as set forth in claim 4 wherein said lateral adjuster includes a micrometer.

6. A measuring assembly as set forth in claim 5 including a cooling device for cooling said chamber to said predetermined temperature.

7. A measuring assembly as set forth in claim 6 including a temperature sensor for measuring temperature in said chamber.

8. A measuring assembly as set forth in claim 7 including an extension extending between said movable part and said tension gauge such that said extension extends through said chamber allowing said tension gauge to be positioned outside said chamber.

9. A measuring assembly as set forth in claim 8 wherein said extension includes an upper portion and a lower portion.

10. A measuring assembly as set forth in claim 9 wherein said extension also included a universal joint separating said upper and lower portions.

11. A measuring assembly as set forth in claim 10 including a linear measuring device for measuring distance traveled by said slide.

12. A measuring assembly as set forth in claim 11 including a holder fixedly secured to said lower portion of said extension for holding the movable part.

13. A measuring assembly as set forth in claim 12 wherein said holder includes a lateral arm for abutting against said lateral adjuster to properly space the movable part with respect to the fixed part.
